(19) United States
(12) Patent Application Publication
(10) Pub. No.: US 2018/0171836 A1
(43) Pub. Date: Jun. 21, 2018

(54) VALVE GUIDE

(71) Applicant: Bleistahl-Produktions GmbH & Co KG, Wetter/Ruhr (DE)

(72) Inventors: Ingwar Hunsche, Bochum (DE); Christian Blecking, Witten (DE); Ekkehard Kohler, Wetter/Ruhr (DE)

(73) Assignee: Bleistahl-Produktions GmbH & Co KG, Wetter/Ruhr (DE)

(21) Appl. No.: 15/735,729

(22) PCT Filed: May 20, 2016
(86) PCT No.: PCT/EP2016/061405

§ 371 Date: Dec. 12, 2017

(30) Foreign Application Priority Data
Jun. 16, 2015 (DE) 10 2015 109 621.8

(51) Int. Cl. F01L 3/08; F01L 3/02; B22F 3/16; B22F 5/00; B23K 20/12; C22C 38/20; C22C 38/04

(52) U.S. Cl. CPC F01L 3/08; F01L 3/02; B22F 3/16; B22F 5/008; B23K 20/12; B23K 2203/04; C22C 38/04; F01L 2101/00; F01L 2103/00; B22F 2301/35; C22C 38/20

(57) ABSTRACT

The invention relates to a valve guide manufactured by powder-metallurgical processes for combustion engines, said guide comprising a central section, a cam-side end piece and a duct-side end piece, wherein the central section consists of a first material and the duct-side end piece of a second material, with the cam-side and/or duct-side end piece being infiltrated with copper.

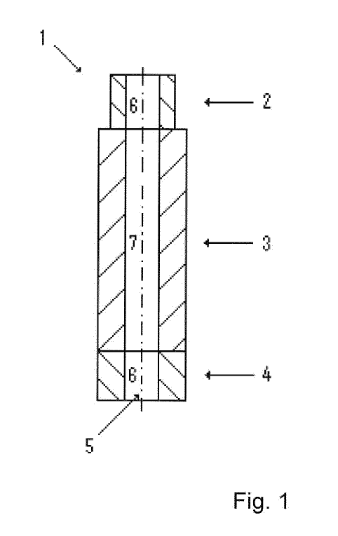

The invention relates to a valve guide manufactured by powder-metallurgical processes for combustion engines, said guide comprising a central section, an end piece facing the cam, and an end piece facing the duct.

Valve guides for combustion engines are located in the cylinder head and serve the purpose of guiding the oscillating valve in such a way that it has close contact with the valve seat ring and in this way is capable of closing off the gas duct.

Valve guides have been manufactured by powder-metallurgical means for many decades. Porosity due to reasons inherent in the manufacturing process is, inter alia, of special advantage because it causes the pores to fill with oil which enhances the lubrication effect between valve guide and valve stem. Good lubrication between these components is necessary because friction is produced due to the oscillating movement.

Basically, a valve guide mounted in a combustion engine can be subdivided into a central section, a cam-side, and a duct-side end piece. All of these sections are exposed to different ambient conditions and have to fulfill different functions.

For example, the duct-side end piece (particularly in outlet valves) is exposed to high temperatures and for that reason must be temperature resistant as well as noncorrosive and resisting wear. It must also have good thermal conductivity for heat dissipation.

The central section, which essentially encompasses the middle area of the valve guide, on the one hand serves the purpose of conducting the heat out of the duct-side end piece and passing it towards the cylinder head (which is cooled). On the other hand, it must also warrant good lubrication between the guide and the valve stem. Moreover, good workability of the central section must also be ensured so that after the engine builder has finished the required machining processes the high dimensional accuracy needed for valve alignment is ensured in the cylinder head.

The cam-side end piece projecting from the cylinder head should also be wear-resistant although due to lower ambient temperatures the impact of wear mechanisms like abrasion and adhesion will be less severe than in the case of the duct-side end piece. Ideally, it is ensured that oil and gas do not exit the cylinder head on the cam side.

Valve guides made of a single material are not capable of satisfying all the functional requirements of the three different sections. For example, a material of high porosity is conducive to the absorption of oil. On the other hand, it is particularly susceptible to corrosion due to its pores. Porosity can also weaken the mechanical properties. Such a material could be suitably employed for the central portion but would be less suited for the duct side. Oil could continue to exit through the pores. Another example is an especially wear resistant material that can only be machined with difficulty which is true for the duct-side material.

A solution to the problem was described in publication GB 780 073 A that proposes to avoid oxidation and corrosion in valve guides manufactured by metallurgical processes. This should be brought about by the provision of a corrosion-resistant metallic cover applied by coating the valve guide or parts of it.

Publication DE 103 43 680 A1 discloses a solution aimed at increasing the tightness of valve guides to oil and gas by the infiltration of the cam-side end with copper.

The above-mentioned publications only offer partial solutions for the various requirements the three sections of the valve guide have to satisfy. Moreover, all the measures referred to above involve noninherent valve guide properties. In fact, to bring about the desired effect additional work steps are needed for a corrosion-resistant cover or a copper sleeve to be provided or arranged for on the valve guide.

Consequently, the objective of the underlying invention is to provide a valve guide manufactured by powder-metallurgical processes, said valve guide consisting of sections made of different materials with a view to meeting all the different and special requirements of the respective sections concurrently.

This objective is achieved by a powder-metallurgically manufactured valve guide of the type first described above, in which the basic body is made of a first material and the end piece on the duct side is made of a second material, with the end piece on the cam and/or the duct side being infiltrated with copper. Insofar as the sintering materials already contain copper, the infiltrated copper is added. Preferably both end pieces are additionally infiltrated with copper. On the one hand, this has the advantage of increasing thermal conductivity in this critical area; on the other hand, however, a high copper content in these areas is improving the sliding ability Aside from pure copper, copper to be used for infiltration is primarily defined as copper alloys having a copper content of more than 90% w/w.

Expediently, the second material is harder than the first one. In this context, the second material preferably has a hardness in excess of 70 HRB, while the first material may have a hardness that is lower by at least 10 HRB.

The invention offers advantages in that the individual sections of the valve guide are adapted to the different needs, also with respect to the material to be used.

In contrast, the central section remains essentially free of infiltrated copper. On the one hand, this can be achieved by individually manufacturing the three segments of the valve guide and then connecting them with each other, wherein the end pieces are infiltrated with copper prior to the connection process, or by a special finishing or treatment or material selection for the central section. Thus, the further absorption of copper by infiltration can be controlled via the manganese content. Copper is absorbed by the capillary action of the pores. If the mean pore size is increased, this results in a reduction of the capillarity and diminishes the absorption capacity for copper. For example, the copper intake in the mentioned areas can be influenced by adjusting the wettability of the surface, for instance, by the respective composition of the first and/or second material, or by controlling the oxidation or reduction behavior during the sintering process with the aid of a chemical treatment or oxidation, or by the application of oxide formers. Optional combinations of these measures are possible.

The cam-side end piece may be manufactured of the first, the second or a third material. Using the first or second material facilitates especially the manufacturing process. The press operation in particular can thus be simplified and shortened. Preferably, also the cam-side end piece consists of the second material.

The materials referred to hereinbefore are for example sintered steel grades having the properties required in each case.

For example, the first material is composed of
78 to 95% w/w Fe,
3 to 20% w/w Cu,
0.8 to 2% w/w Mn,
0.4 to 0.6% w/w S and
0.8 to 2% w/w C

The composition refers to the sintered material and does not include infiltrated copper that may have been added.

Further elements/alloying constituents may exist up to a total amount of 4% w/w.

A concrete composition example of the first material is as follows:
84% w/w Fe,
12% w/w Cu,
1.5% w/w Mn,
0.5% w/w S,
0.9% w/w C
additional elements/alloying constituents up to 100% w/w,
   with the copper content of the first material not including infiltrated copper.

The copper content added by sintering ensures a certain thermal conductivity. In this way, the central section is capable of transferring the high temperatures arising at duct-side and valve to the cam-side. The copper is added to the mixture in the form of copper or copper alloy powder before the pressing operation. Sulfur (S) in the form of metal sulfides, e.g. manganese sulfide (MnS), but also plastics serve as solid lubricants and enhance the emergency operating characteristics of the tribological system of guide and stem in the event an insufficient amount of engine oil is available for lubrication. The composition of the first material warrants good machinability.

For example, the second material is composed of
80 to 86% w/w Fe,
1.0 to 10% w/w Cr,
5 to 16% Cu,
0.6 to 0.8% w/w Mn,
0.4 to 0.6% w/w S and
0.5 to 2.0% w/w C and
if necessary, further elements/alloying constituents that may amount to up to 3.5% w/w.

The composition refers to the sintered material, without infiltrated copper.

A concrete composition example of the second material is as follows:
84% w/w Fe,
1.2% w/w Cr,
12% w/w Cu,
0.7% w/w Mn,
0.5% w/w S,
0.6% w/w C und
additional elements/alloying constituents up to 100% w/w,
   with the copper content of the second material not including infiltrated copper.

A difference in comparison to the first material is the chromium content which results in higher wear resistance due to the formation of chromium carbides and in a solid solution solidification. Moreover, the second material is capable of withstanding high temperatures as well as high abrasive wear over a long period of time. Due to the higher temperatures it is exposed to, the duct-side end piece, as a rule, is prone to suffer more severe wear than the cam-side one. For that reason, the second material features excellent wear resistance.

As wear mechanisms in valve guiding components for combustion engines, adhesion and abrasion are frequently encountered. These arise between valve guide and valve stem and are found to be more pronounced on the duct side than on the cam side. Major problems with wear are experienced in outlet valve guide systems. These lead to an increase in gap width between valve guide and the valve stem. Particles can thus enter the sliding area and cause the valve stem to become jammed. This results in an engine failure. Therefore, the copper content of the second material contributes additionally to improving the mechanical properties such as hardness and strength. Copper infiltration further improves the thermal and mechanical properties.

The first and the second material may differ with respect to hardness, wherein the lower hardness of the first material of the central section in comparison to the second material of the duct-side end piece warrants good machinability whereas the harder material of the duct-side end piece greatly enhances the wear resistance as well as temperature resistance.

A typical thermal conductivity of the central section of valve guides manufactured by powder metallurgical processes ranges between 21 and 48 W/(mK). In contrast, the end pieces preferably have an increased thermal conductivity of between 40 and 80 W/(mK).

In comparison to other valve guide systems (e.g. of cast design), powder-metallurgically manufactured valve guides offer advantages in that they possess pores that can absorb a certain amount of oil. A higher oil content leads to improving the lubrication efficiency of the valve guide. In view of the constant friction arising between valve guide and valve stem this is to be considered a significant benefit.

The density of powder-metallurgically manufactured valve guides on Fe basis is customarily approx. 7 g/cm³. This results in a porosity of approx. 10%. Since the central section requires high porosity, the porosity of the first material should range between 10 and 20%, preferably between 15 and 20%, and especially preferred between 17 and 20%. The porosity of the central section is important with respect to the oil absorption capability and has an impact on the tribological characteristics.

The pore size of the central section is preferably in the range from 10 to 400 μm, preferably in the range from 50 to 400 μm and in particular ranges between 100 and 350 μm. In this pore size range, the capillary action of the pore compound is reduced and not sufficient to absorb large amounts of copper into the body during copper infiltration. At the same time, the pore size and pore volume are favorable for the oil absorption of the valve guide.

Expediently, the second material has a porosity of 8 to 15% and preferably between 8 and 12%. The pore size, for example, ranges between 10 and 400 μm, preferably between 10 and 350 μm and in particular between 50 and 250 μm. In this context, the capillarity for copper infiltration plays an important role.

In an embodiment of the invention, the powder-metallurgically produced valve guide may additionally be provided with copper infiltration applied to the cam side. This increases the tightness to oil and gas and additionally reduces the consumption of engine oil which is detrimental to the environment. The copper infiltration reaches into the area extending maximally from the outer surface down to the wall center of the cam-side end piece, however preferably into the area of the surface layer zone which has a thickness of one to three millimeters.

Manufacture of the inventive valve guide may take place in five steps. In a first step, the powder for the duct-side end piece composed of the second material is filled into a die arranged coaxially to a punch and, if expedient, precompacted by means of a pressing tool, in a second step the powder for the central section consisting of the first material is to be filled into the die and, if appropriate, precompacted by means of the pressing tool, in a third step the powder for the cam-side end piece consisting of the second or a third material is to be filled into the die and, if expedient, precompacted by means of the pressing tool, in a fourth step the entire valve guide is compacted in the die using the pressing tool, wherein the form of the compact is particularly determined by the form of the die and of the punch, and in a fifth step the entire valve guide is sintered. However, the compaction sequence of the valve guide sections may also be reversed so that at first the duct-side end piece, then the central section, and lastly the cam-side end piece are compacted. It goes without saying that a work step may be omitted in the event the central section and the cam-side end piece are composed of the same material. Moreover, the cam-side end piece may as well be manufactured of a third material. The individual compaction steps may be merged into a single step so that the intermediate compaction steps can be omitted.

Pressing additives, for example wax, can be added to the powder mixture to improve the cohesion of the compact. During the subsequent sintering process the wax will evaporate completely and in this way will no longer be present in the sintered valve guide.

Contrary to methods providing for the valve guides to be manufactured of a single material the present method offers the advantage that density and porosity of the central section can be well adjusted by means of the pressing operation.

In a special embodiment of the method the compacted valve guide and a copper body may be sintered together, wherein the copper body is in close contact with or resting on the cam-side and/or duct-side of the compacted valve guide and with respect to its weight is appropriately adjusted to suit the amount of copper to be infiltrated. Preferably, the copper body is provided in the form of a plate, a sleeve or a bar. As a result of the copper infiltration, the end pieces can reach a total copper content of up to 40% w/w. In contrast, the total copper content of the central section remains below 30% w/w, preferably below 20% w/w.

The individual elements or sections of the valve guide may also be manufactured separately and be subsequently joined with each other by friction welding. In this case, the end pieces can be individually infiltrated with copper before they are connected to the central section.

The figure is a sectional view showing by way of example an embodiment of valve guide 1 as proposed by the invention. The valve guide consists of a cam-side end piece 2, a central section 3, and a duct-side end piece 4. The bore in which the valve stem moves has been given reference numeral 5. In this embodiment the central section consists of a first material 7, and the cam-side and duct-side end piece consist of a second material 6.

The invention also relates to the use of powder-metallurgically manufactured guides in the engine and mechanical engineering field, said guides consisting of the triple-layer structure described above, with a central section made of a first material, a head portion made of a second material as well as a foot portion, with the head and/or foot portion being infiltrated with copper.

1. Valve guide manufactured by powder-metallurgical processes for combustion engines, said guide comprising a central section, an end piece facing the cam, and an end piece facing the duct, characterized in that the central section consists of a first material and the duct-side end piece of a second material, wherein the cam-side and/or duct-side end piece are infiltrated with copper.

2. Valve guide according to claim 1, characterized in that the cam-side end piece consists of the first, of the second or of a third material.

3. Valve guide according to claim 1, characterized in that the first material consists of 78 to 95% w/w Fe, 3 to 20% w/w Cu, 0.8 to 3% w/w Mn, 0.4 to 0.6% S, 0.8 to 1% w/w C, and up to 4% w/w of further elements, with infiltrated copper not being taken into account.

4. Valve guide according to claim 1, characterized in that the second material consists of 80 to 86/w Fe, 1.1 to 1.3% w/w Cr, 12 to 16% w/w Cu, 0.6 to 0.8% w/w Mn, 0.4 to 0.6% w/w 5, 0.5 to 0.7% w/w C, and 0.9 to 1.1% w/w Sn, with infiltrated copper not being taken into account.

5. Valve guide according to claim 1, characterized in that the first material for the central section has a thermal conductivity ranging between 21 and 48 W/(mK) and/or the second material has a thermal conductivity of between 40 and 80 W/(mk).

6. Valve guide according to claim 1, characterized in that the first material has a porosity ranging between 10 and 20% and preferably between 15 and 20%.

7. Valve guide according to claim 1, characterized in that the first material has a porosity of 15 to 20% at a pore size in the range of between 10 and 400 μm, and/or the second material has a porosity of 8 to 15% at a pore size in the range of between 10 and 400 μm.

8. Valve guide according to claim 7, characterized by a porosity of the first material of between 17 and 20% at a pore size in the range of 100 to 350 μm.

9. Method for the manufacture of a valve guide according to claim 1, characterized in that at first the powders for the individual sections of the valve guide are successively filled into a die which is arranged coaxially to a punch, and, following which, the entire valve guide in the die is compacted by means of a pressing tool, with the form of the compact being in particular determined by the form of the die and the punch, and with the entire valve guide being sintered in a final work step.

10. Method according to claim 9, characterized in that a precompaction step is carried out for at least one of the filling steps.

11. Method for the manufacture of a valve guide according to claim 1, characterized in that the individual sections of the valve guide are produced in a powder metallurgical way by compaction and sintering and joined by friction welding to form the valve guide.

12. Use of powder-metallurgically manufactured guides in the mechanical and engine engineering field, said guides consisting of a triple-layer structure, with a central section, a head portion and a foot portion, with the head and/or foot portion being infiltrated with copper.
